(19) United States
(12) Patent Application Publication
(10) Pub. No.: US 2009/0265048 A1
(43) Pub. Date: Oct. 22, 2009

(54) Remote startup device, remote startup system, and remote startup method

(75) Inventors: Yasuo Ono, Kobe-shi (JP); Nobuhito Yamazaki, Kobe-shi (JP); Masashi Kumano, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/385,701

(22) Filed: Apr. 16, 2009

(30) Foreign Application Priority Data
Apr. 18, 2008 (JP) 2008-109296
Apr. 9, 2009 (JP) 2009-94574

(51) Int. Cl. G06F 19/00

(52) U.S. Cl. 701/2

(57) ABSTRACT

An object of this invention is to improve convenience to a user when starting up an engine remotely, without detracting from safety with respect to vehicle theft. A remote startup device has an engine startup control unit, which starts the engine in response to a startup instruction signal, and an engine running control unit, which decides, after the engine has been started up, whether to continue or to stop running of the engine based on prescribed conditions. The engine running control unit continues running of the engine when detecting a key at the time of unlocking of a door of the vehicle and at the time of ignition action, and stops running of the engine when not detecting a key either at the time of the door unlocking or at the time of the ignition action, to thereby secure safety with respect to theft.

### CROSS-REFERENCE TO RELATED APPLICATIONS

This application is based upon and claims the benefits of priority from the prior Japanese Patent Application No. 2008-109296, filed on Apr. 18, 2008, and the prior Japanese Patent Application No. 2009-94574, filed on Apr. 9, 2009, the entire contents of which are incorporated herein by reference.

### BACKGROUND OF THE INVENTION

1. Field of the Invention

This invention relates to a remote startup device and so on to start up an engine of a vehicle by remote control, and in particular relates to technology to prevent vehicle theft by a third party upon the occasion of remote startup of an engine.

2. Description of the Related Art

In recent years, remote startup devices have been known which start an engine by remote control while the user is outside the vehicle, in order to operate the heating or air-conditioning of the vehicle prior to driving. A remote startup device receives a startup instruction signal transmitted wirelessly from a remote control terminal carried by the user, and in response starts the engine, to execute remote engine startup. An example of a remote startup device which performs such remote startup is disclosed in Japanese Patent Application Laid-open No. 2006-248471.

When remote startup is executed, even when the user is not inside or near the vehicle, the vehicle engine is in the running state, so that there are concerns that a third party may intrude into the vehicle and drive the vehicle away. Hence as a method of preventing theft of the vehicle, a method has been proposed in which, upon detection of actions performed upon entering a vehicle, such as unlocking of doors and opening of windows of the vehicle, the remote startup device stops the engine. By means of this method, a vehicle occupant cannot drive the vehicle without using a portable key to manually operate the ignition switch and restart the engine. Hence theft of the vehicle by an intruder not possessing a legitimate key can be prevented.

However, in the case of the above method, the engine must be restarted even when a user possessing a legitimate key enters the vehicle and drives the vehicle. Despite once having started the engine remotely, the user must go to the trouble of restarting the engine, so that convenience to the user is impaired.

### SUMMARY OF THE INVENTION

Hence an object of this invention is to provide a remote startup device and similar which improve convenience to the user, without detracting from safety with regard to vehicle theft during remote startup of the engine.

In order to attain the above object, a first mode of the invention provides a remote startup device, which starts an engine of a vehicle upon receiving wireless transmission of a startup instruction signal instructing startup of the engine, and has an engine startup control unit, which starts the engine in response to the startup instruction signal; an action monitoring unit, which monitors actions performed on the vehicle; and an engine running control unit, which decides, after the engine has been started up, whether to continue or to stop running of the engine based on prescribed conditions, and is characterized in that the engine running control unit detects a key at least two times, which are at the time of unlocking of a door of the vehicle and at the time of ignition connection, and continues running of the engine when the key is detected at both times, and stops running of the engine when the key is not detected at least one of the two times.

A second mode of the invention provides a remote startup device, having an engine startup unit, to which a startup instruction signal instructing startup of an engine of a vehicle is wirelessly transmitted, and which changes a control signal to on to put the engine into a running state in response to this startup instruction signal, and an action monitoring unit, which monitors prescribed user actions performed on the vehicle after the control signal is changed to on, and is characterized in that the engine startup unit executes a first operating mode in which, after the control signal is changed to on, the on value of the control signal is maintained until the user actions end, and when an action to operate a prescribed portion of the vehicle, among the user actions, is performed without using a portable key, the control signal is changed to off.

A third mode of the invention provides a remote startup system, having a remote control terminal, which wirelessly transmits a startup instruction signal instructing startup of an engine of a vehicle, and a remote startup device, which is mounted on the vehicle and receives the startup instruction signal, and is characterized in that the remote startup device has an engine startup unit which changes a control signal to on to put the engine into a running state in response to the startup instruction signal, and an action monitoring unit which monitors prescribed user actions performed on the vehicle after the control signal is changed to on, and in that the engine startup unit executes a first operating mode in which, after the control signal is changed to on, the on value of the control signal is maintained until the user actions end, and when an action to operate a prescribed portion of the vehicle, among the user actions, is performed without using a portable key, the control signal is changed to off.

By means of this invention, user convenience can be improved, without detracting from safety with regard to vehicle theft during remote startup of the engine.

### BRIEF DESCRIPTION OF THE DRAWINGS

FIG. 1 explains an example of the configuration of the remote startup device of a first embodiment;

FIG. 2 shows an example of the configuration of an ignition signal detection portion 24;

FIG. 3 explains the operation procedure of the remote startup device 20 when the engine is started up remotely;

FIG. 4 is a flowchart explaining the operation procedure of the action monitoring unit 20b;

FIG. 5 is a flowchart showing the operation procedure of the subroutine in FIG. 4;

FIG. 6 is a flowchart explaining the operation procedure of the remote startup device 20 in a first modified example;

FIG. 7 is a flowchart explaining an example in the first modified example of the operation procedure of the action monitoring unit 20b shown in FIG. 4;

FIG. 8 is a flowchart explaining an example in the first modified example of the operation procedure of the action monitoring unit 20b shown in FIG. 5;

FIG. 9 shows an example of the configuration when the engine startup device 20 and immobilizer are combined;

FIG. 10 is a flowchart explaining the operation procedure of the remote startup device 20 in a second modified example;

FIG. 11 is a block diagram explaining the configuration of the remote startup device in the second embodiment;

FIG. 12 is a flowchart explaining the operation procedure of the action monitoring unit 20b in the second embodiment;

FIG. 13 is a flowchart explaining the operation procedure of the action monitoring unit 20b in a first modified example;

FIG. 14 is a flowchart of the subroutine in the second modified example; and

FIG. 15 is a flowchart explaining the operation procedure of the action monitoring unit 20b in the second modified example.

### DESCRIPTION OF THE PREFERRED EMBODIMENTS

Below, embodiments of the invention are explained referring to the drawings. However, the technical scope of the invention is not limited to these embodiments, but extends to the inventions described in the scope of claims, and to inventions equivalent thereto.

### 1. First Aspect

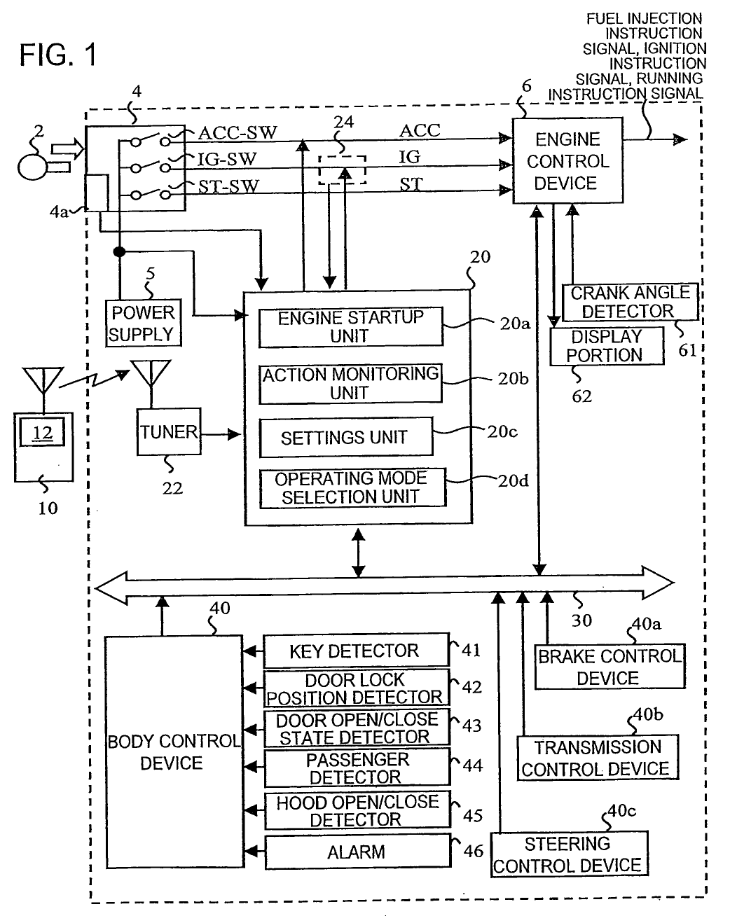

FIG. 1 explains an example of the configuration of a remote startup device of a first embodiment. In response to a startup instruction signal transmitted wirelessly from a remote control terminal 10, this remote startup device 20 can remotely start up the engine by outputting to the engine control device 6 a control signal similarly to a case in which the user uses a portable key 2 to start up the engine manually.

First, when the user performs engine startup by manual action, the user inserts the key 2 into the key cylinder 4 and rotates the key cylinder 4, to mechanically connect in sequence the accessory switch ACC-SW, ignition switch IG-SW, and starter switch ST-SW. Then, as a result of the voltage supplied from the onboard power supply 5, the accessory signal ACC, ignition signal IG, and starter signal ST input to the engine control device 6 are turned on (set to H level) in sequence.

The engine control device 6 starts when the accessory signal ACC changes to on, and when the ignition signal IG changes to on, a fuel injection instruction signal and an ignition instruction signal begin to be output to the injector and to the spark plug respectively. And, when the start signal ST changes to on, the engine control device 6 begins output of a running instruction signal to the starter motor. Then engine cranking, fuel injection and ignition are executed, and the engine is started.

Based on the crank angle detected by a crank angle sensor 61, the engine control device 6 calculates the engine rotation rate, and the engine rotation rate is output to the display portion 62. And, when the user confirms that the rotation rate desired has been reached and turns the key cylinder 4 to open the starter switch ST-SW, the start signal ST changes to off, and the starter motor stops. On the other hand, the accessory signal ACC and ignition signal IG are maintained in the on state, so that the engine control device 6 continuous to issue fuel injection instructions and ignition instructions in synchronization with the engine rotation. At this time, the engine can run autonomously, and engine startup is completed.

And, when after stopping the vehicle the user rotates the key cylinder 4 to open the ignition switch IG-SW, the ignition signal IG changes to off. As a result, the fuel injection and ignition are stopped, and so the engine stops.

When the user remotely starts up the engine, the user performs an action to input a remote startup instruction to the action portion 12 of the remote control terminal 10, and as a result a startup instruction signal is transmitted wirelessly from the remote control terminal 10 instructing startup of the engine. The action portion 12 of the remote control terminal 10 comprises, for example, pushbuttons. The startup instruction signal is received by a tuner 22 on the vehicle side, and is captured by the remote startup device 20.

The remote startup device 20 comprises for example a microcomputer, and has a CPU (Central Processing Unit), ROM (Read-Only Memory) capable of storing various control programs describing operation procedures for the CPU, an RAM (Random Access Memory) used as a workspace when the CPU performs computations. Here, an engine startup unit 20a, action monitoring unit 20b, settings unit 20c, and operating mode selection unit 20d are each realized by a program describing operation procedures, described below, and the CPU which operates according to the program.

In response to the startup instruction signal, the engine startup unit 20a inputs pseudo-on signals to the signal lines of the accessory signal ACC, ignition signal IG, and starter signal ST by means of the voltage supplied from the onboard power supply 5. By this means, even when the accessory switch ACC-SW, ignition switch IG-SW, and starter switch ST-SW are in the open state, engine startup operation similar to that above is executed by means of the accessory signal ACC, ignition signal IG, and starter signal ST input to the engine control device 6.

And, when the engine rotation rate input via a vehicle LAN (Local Area Network) 30 from the engine control device 6 reaches a prescribed rotation rate, the engine startup unit 20a changes the starter signal ST to off, while maintains the ignition signal IG at the on value. By this means, the engine running state is preserved until the user enters the vehicle. Here, the ignition signal IG corresponds to a “control signal” which keeps the engine in the running state.

After remote engine startup has been executed, when the user enters the vehicle, inserts the key 2 into the key cylinder 4 and rotates the key cylinder 4, the accessory switch ACC-SW is connected, the accessory signal ACC output by the accessory switch ACC-SW changes to on, and next the ignition switch IG-SW is connected and the ignition signal IG output by the ignition switch IG-SW changes to on. Then, the ignition signal IG detection portion 24 detects this change and inputs a detection signal to the remote startup device 20. The engine startup unit 20a changes the ignition signal IG and accessory signal ACC which it itself outputs to off. Thereafter, the ignition signal IG is maintained at the on value until the key cylinder 4 is rotated and the ignition switch IG-SW is opened, so that the running state of the engine is preserved.

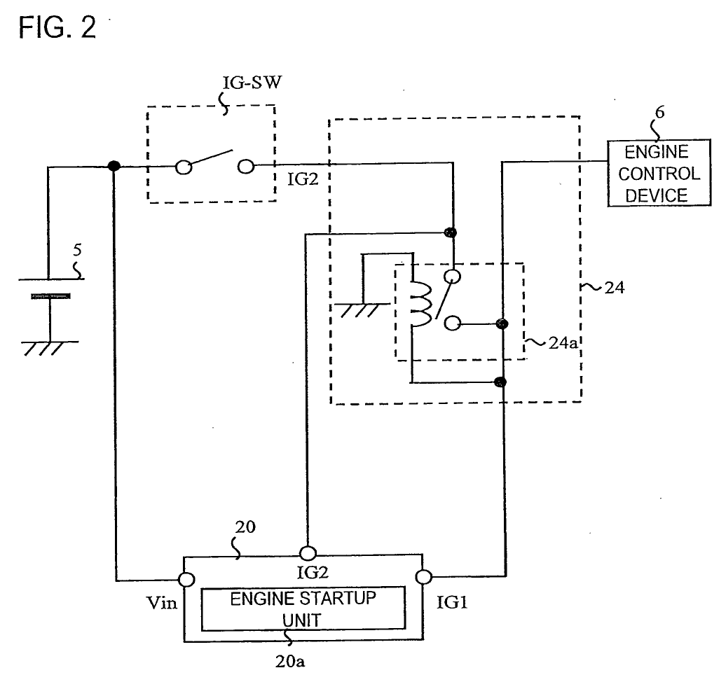

Here, an example of the configuration of the ignition signal detection portion 24 is described using FIG. 2. The ignition signal 24 detection portion has a normally-closed electromagnetic relay 24a which opens and closes the signal line connecting the ignition switch IG-SW and the engine control device 6. When remote startup is performed with the ignition switch IG-SW in the open state, the engine startup unit 20a of the remote startup device 20 changes the ignition signal IG1 to on (H level) by means of the input voltage Vin from the onboard power supply 5. Then, through application of the ignition signal IG1 to the coil of the electromagnetic relay 24a, the electromagnetic relay 24a enters the open state, and the ignition signal IG1 is input to the engine control device 6 as the ignition signal IG. Then, when the ignition switch IG-SW is connected through user action, the H level ignition signal IG2 is detected via the ignition signal detection portion 24 and is input as a detection signal to the remote startup device 20. The engine startup unit 20a then changes the ignition signal IG1 to L level, changing the value to off. Together with this, the electromagnetic relay 24 enters the connected state, and the ignition signal IG2 from the ignition switch IG-SW is input to the engine control device 6 as the ignition signal IG.

When remote engine startup is executed in this manner, in order to prevent theft of the vehicle by intrusion into the vehicle and driving of the vehicle by a third party in advance of the user, when there is a high probability of intrusion by a third party, the remote startup device 20 changes the ignition signal IG to off, to stop the engine.

Here, when a vehicle door is unlocked it is judged that there is a high probability of intrusion by a third party, and an action is possible in which the door unlocking is detected and the engine is stopped (hereafter this operating mode is called the normal mode). However, when this normal mode is executed, the engine is stopped even when the legitimate user unlocks a door in order to enter the vehicle, and so the user must again start up the engine in order to drive the vehicle.

Hence in the first embodiment, the action monitoring unit 20b of the remote startup device 20 detects actions and positions of various portions of the vehicle, in order to monitor a series of actions executed on the vehicle, that is, the unlocking of doors, opening of doors, entry into the vehicle, closing of doors, and connection of the ignition switch IG-SW. These user actions are normally performed when a user possessing a legitimate key enters the vehicle and begins driving, and so by monitoring these action states, it is possible to judge whether a legitimate user is entering the vehicle, or whether a third party is intruding. The above user actions are one example; user actions may be a portion of the above actions, or may comprise actions other than the above.

Here, as a first case in which the probability of intrusion by a third party is high, a case is considered in which actions to unlock a door and to connect the ignition switch IG-SW, which normally are performed using a key 2, are performed without using a key 2, that is, without detection of insertion of a key 2. In this case, there is the possibility that a third party has used a metal rod, wire, or similar to unlock a door, or has operated the ignition switch IG-SW, and so it can be judged that there is a high probability of intrusion by a third party. As a second case, when a user action does not end within a prescribed action time (for example, within several tens of seconds to several minutes after the unlocking of a door), there is the possibility that a third party is attempting to disarm the alarm and connect a signal line by removing the ignition switch IG-SW, and so it can be judged that there is a high probability of intrusion by a third party. And as a third case, when a suspicious action other than a user action is performed, such as for example the hood being opened and closed, the alarm sounding, or the battery being removed, it can be judged that there is a high probability of intrusion by a third party. In particular, when a shift action, braking action, steering action, or similar is performed, it can be judged that there is a high probability of an attempt at theft after a third party has intruded into the vehicle.

In cases such as those described above, the engine startup unit 20a changes the ignition signal IG to off to stop the engine, and prevents theft of the vehicle. On the other hand, when a legitimate user is entering the vehicle, the engine startup unit 20a maintains the ignition signal IG at the on value, and preserves the running state of the engine (below, this operating mode is called the continuous running mode, in contrast with the normal mode). By this means, the engine running state is preserved when the user enters the vehicle, so that the user can drive the vehicle without the need to again start up the engine. Hence convenience to the user can be improved.

In this continuous running mode, in order to enable the action monitoring unit 20b to monitor user actions, various signals relating to the vehicle state are input to the remote startup device 20. Specifically, a key detection signal indicating insertion of a key 2 into the key insertion hole of a door lock, a door lock position signal indicating the door lock position corresponding to door locking/unlocking, a door open/closed signal indicating the open/closed state of a door, a passenger detection signal indicating detection of a passenger within the vehicle, and an alarm operation signal indicating operation of an alarm, are input from a body control device 40. The body control device 40 obtains a key detection signal from a key detector 41, which electrically or mechanically detects insertion of a key 2 into the key insertion hole of a door lock, obtains a door lock position signal from a door lock position detector 42, obtains a door open/closed signal from a door state detector 43, obtains a passenger detection signal from a passenger detector 44 which detects passengers in the vehicle using infrared rays, and obtains an alarm operation signal from an alarm 46. A key detection signal is input to the remote startup device 20 from a key detector 4a, which electrically or mechanically detects insertion of a key 2 into the key cylinder 4.

Further, signals to monitor actions other than user actions are input to the remote startup device 20. Specifically, a hood open/close signal, indicating that the vehicle hood has been opened or closed, is input from the body control device 40. At this time, the body control device 40 detects the hood open/closed state by means of a hood open/close detector 45. A brake action signal indicating that the brakes have been operated is input from a brake control device 40a, a transmission signal indicating that the transmission has been operated is input from a transmission control device 40b, and a steering signal indicating that the steering has been operated is input from a steering control device 40c. The body control device 40, brake control device 40b, and transmission control device 40c send detection signals to the remote startup device 20 via a vehicle LAN 30 which adopts CAN (Controller Area Network) or another communication method. In addition, the action monitoring unit 20b monitors the voltage of the onboard power supply 5 to detect removal of the onboard power supply 5.

Further, the setting unit 20c of the remote startup device 20 performs settings enabling selection of the normal mode or continuous running mode based on a setting signal transmitted from the remote control terminal 10. And, the operating mode selection unit 20d selects either the normal mode or the continuous running mode in response to the selection signal transmitted from the remote control terminal 10, and the engine startup unit 20a executes operation in the selected operating mode. Thus the user can select the desired operating mode.

The settings and selection made by the user are input to the action portion 12 of the remote control terminal 10. At this time, the settings and selection are input through the pushbutton action pattern (the types of buttons pushed, pushing time, order and combination of buttons pushed, and similar). An arbitrary action pattern can also be registered by the user in rewritable ROM within the remote control terminal 10. And, a display portion can be provided in the remote control terminal 10 to display selection results. Or, the correspondence relation between an action pattern and the settings and selection are stored in advance in ROM within the remote startup device 20, an action signal corresponding to actions on the action portion 12 is transmitted from the remote control terminal 10, and the settings unit 20c or operating mode election unit 20d of the remote startup device 20 may then make the settings or selection corresponding to the action signal.

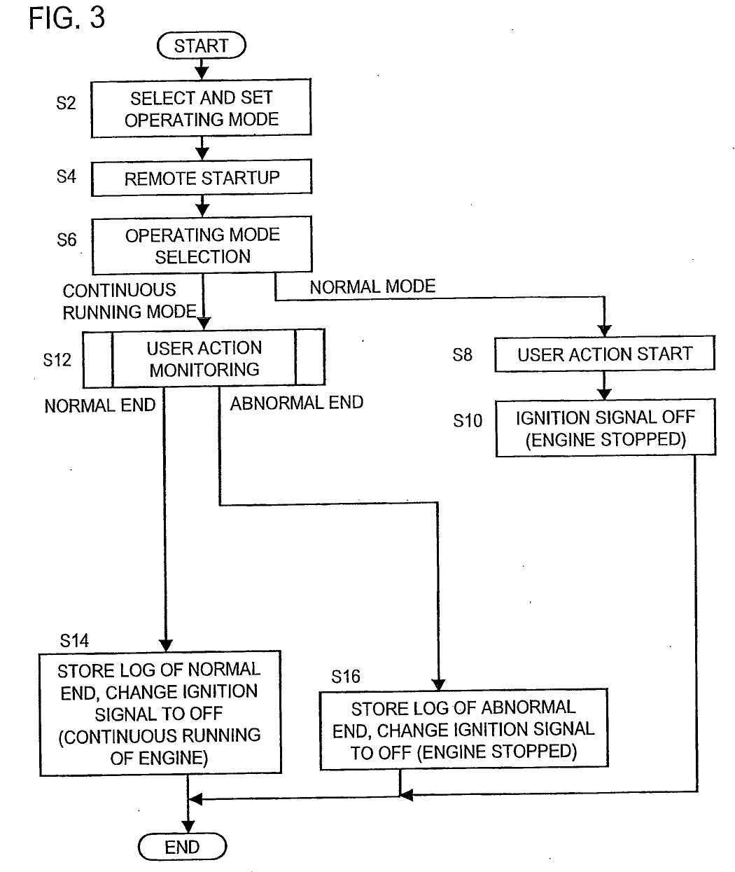

FIG. 3 explains the operation procedure of the remote startup device 20 when the engine is remotely started up. First, the user inputs a setting from the remote control terminal 10 indicating whether to enable selection of continuous running mode or normal mode as the operating mode; when the setting signal corresponding to the user setting is transmitted, the settings unit 20c sets the operating modes as either enabled or disabled based on the setting signal (S2).

Next, when the user inputs an action to the action portion 12 of the remote control terminal 10 instructing engine startup, a startup instruction signal is transmitted from the remote control terminal 10, and so in response to this the engine startup unit 20a changes the ignition signal IG to on, and executes remote startup (S4). Further, when the user selects and inputs normal mode or continuous running mode to the action portion 12 of the remote control terminal 10, a selection signal corresponding to the operating mode is transmitted from the remote control terminal 10. Then, the engine startup unit 20a selects the operating mode corresponding to the selection signal (S6). In this way, the user can select the desired operating mode and cause the remote startup device 20 to execute the mode. That is, in cases in which safety with respect to theft is emphasized, the normal mode can be selected, and when emphasizing convenience upon entering the vehicle, the continuous running mode can be selected.

When the normal mode is selected (“Normal mode” in S6), the action monitoring unit 20b detects unlocking of door locks, that is, the beginning of user actions (S8), and the engine startup unit 20a changes the ignition signal IG to off and stops the engine (S10). By this means, vehicle theft is prevented.

On the other hand, when the continuous running mode is selected (“Continuous running mode” in S6), the action monitoring unit 20b monitors a series of user actions (S12).

Here, when the action monitoring unit 20b does not detect an abnormal action state, that is, while user actions are being performed normally, the engine startup unit 20a maintains the on value of the ignition signal IG, and the engine running state is preserved. On the other hand, if the action monitoring unit 20b detects an anomalous action state, user action monitoring ends abnormally. An abnormal action state results from the three cases described above in which there is a high probability of intrusion by a third party. That is, the first is a case in which actions such as unlocking of doors and connection of the ignition switch IG-SW which are performed using a key 2 are executed without using a key 2. The second is a case in which a user action does not end within a prescribed action time. And the third is a case in which actions other than user actions are performed in the midst of user actions.

When all user actions end normally (“Normal end” in S12), the engine startup unit 20a stores a log of the normal end of user actions in ROM in the remote startup device 20, and changes to off the ignition signal IG which it outputs (S14). By this means, the user can drive the vehicle without the need to again start up the engine.

When user actions end abnormally (“Abnormal end” in S12), the engine startup unit 20a stores a log of the abnormal end of user actions in ROM, and changes to off the ignition signal IG which it outputs (S16). By this means, the engine is stopped, and vehicle theft is prevented. The log stored in ROM is referenced when an anomaly occurs in action of the remote startup device 20 and when studying theft countermeasures.

Here, the action procedure of the action monitoring unit 20b in S12 is explained in detail.

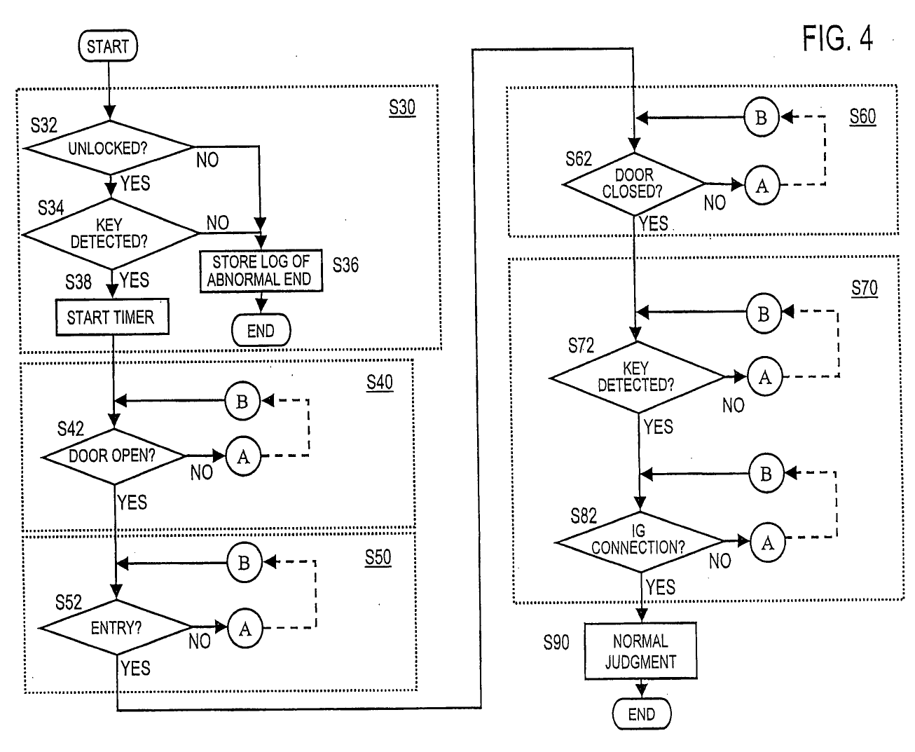

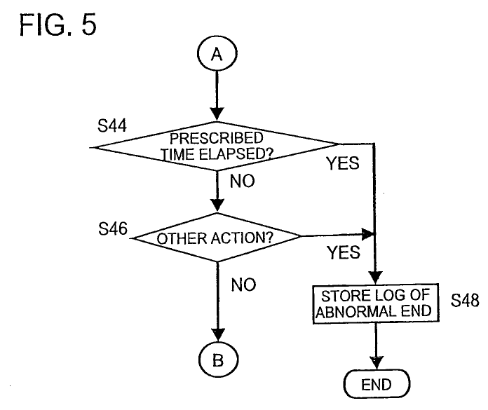

FIG. 4 is a flowchart explaining the operation procedure of the action monitoring unit 20b. FIG. 5 is a flowchart showing the operation procedure of the subroutine in FIG. 4.

As shown in FIG. 4, the action monitoring unit 20b executes, in order, a door unlocking monitoring procedure S30, door opening monitoring procedure S40, passenger entry monitoring procedure S50, door closing monitoring procedure S60, and ignition switch IG-SW connection monitoring procedure S70.

First, in the door unlocking monitoring procedure S30, when a door is unlocked (“YES” in S32), the action monitoring unit 20b judges whether a key 2 is inserted into the door lock key insertion hole (S34); if a key 2 is inserted (“YES” in S34), that is, of the door has not been unlocked by an illicit action, a timer which measures a prescribed action time is started (S38), and processing proceeds to the door open monitoring procedure S40. If on the other hand a key 2 is not detected in the procedure S34 (“NO” in S34), a log indicating that a key 2 was not detected is stored in internal RAM of the remote startup device 20, and the action monitoring procedure S12 ends abnormally (S36).

Next, in the door opening monitoring procedure S40, when the door is opened (“YES” in S42), the action monitoring unit 20b proceeds to the passenger entry monitoring procedure S50. If on the other hand the door open state is not detected (“NO” in S42), the subroutine of FIG. 5 is executed (procedure A). In the subroutine of FIG. 5, when after a prescribed time has elapsed (“YES” in S44) but before another prescribed time has elapsed (“NO” in S44) an action other than door-opening is executed (“YES” in S46), the action monitoring unit 20b stores a log of the action state in internal RAM of the remote startup device 20 (S48), and the action monitoring procedure S12 ends abnormally.

In this way, when in the door opening monitoring procedure S40 the action monitoring unit 20b detects a door opening (“YES” in S42) without detecting an action other than the door opening (“NO” in S46; procedure B) prior to elapse of a prescribed time (“NO” in S44), the door unlocking monitoring procedure S30 ends normally, and processing proceeds to the passenger entry monitoring procedure S50.

Next, in the passenger entry monitoring procedure S50, when the action monitoring unit 20b detects entry of a passenger (“YES” in S52), processing proceeds to the door closing monitoring procedure S60. If on the other hand passenger entry is not detected (“NO” in S52), similarly to the above processing, the subroutine of FIG. 5 is executed (procedure A). Hence in the passenger entry monitoring procedure S50, when the action monitoring unit 20b detects entry of a passenger (“YES” in S52) prior to elapse of a prescribed time (“NO” in S44) without detecting an action other than passenger entry (“NO” in S46; procedure B), the passenger entry monitoring procedure S50 ends normally. On the other hand, when the prescribed time has elapsed (“YES” in S44), and when an action other than entry is executed (“YES” in S46) prior to elapse of the prescribed time (“NO” in S44), a log of the action state is stores in the internal RAM of the remote startup device 20 (S48), and the action monitoring procedure S12 ends abnormally.

Next, in the door closing monitoring procedure S60, when the action monitoring unit 20b detects a door closing (“YES” in S62), processing proceeds to the ignition switch IG-SW connection monitoring procedure S70. On the other hand, when door closing is not detected (“NO” in S62), similarly to the above, the subroutine of FIG. 5 is executed (procedure A). Hence in the door closing monitoring procedure S60, when the action monitoring unit 20b detects the door closing (“YES” in S62) before the prescribed time elapses (“NO” in S44) without detecting an action other than door closing (“NO” in S46; procedure B), the door closing monitoring procedure S30 ends normally. On the other hand, when the prescribed time has elapsed (“YES” in S44), and when an action other than door closing is executed (“YES” in S46) before the prescribed time has elapsed (“NO” in S44), a log of the action state is stored in the internal RAM of the remote startup device 20 (S48), and the action monitoring procedure S12 ends abnormally.

Next, in the first half of the ignition switch IG-SW connection monitoring procedure S70, the action monitoring unit 20b, upon detecting insertion of a key 2 (“YES” in S72), first proceeds to S82, but when insertion of a key 2 is not detected (“NO” in S72), executes the subroutine of FIG. 5 (procedure A). That is, when the action monitoring unit 20b detects insertion of a key 2 (“YES” in S72) before the prescribed time has elapsed (“NO” in S44) without detection an action other than insertion of a key 2 (“NO” in S46; procedure B), processing proceeds to S82. On the other hand, when the prescribed time has elapsed (“YES” in S44), or when an action other than insertion of the key 2 is executed (“YES” in S46) before the prescribed time has elapsed (“NO” in S44), a log of the action state is stored in the internal RAM of the remote startup device 20 (S48), and the action monitoring procedure S12 ends abnormally.

Next, in the second half of the ignition switch IG-SW connection monitoring procedure S70, when the ignition signal detection portion 24 detects connection of the ignition switch IG-SW (“YES” in S82), the action monitoring unit 20b proceeds to S90, and the action monitoring procedure S12 ends normally (S90). If on the other hand connection of the ignition switch IG-SW is not detected (“NO” in S82), the subroutine of FIG. 5 is executed (procedure A). That is, when the ignition switch IG-SW connection is detected (“YES” in S82) before the prescribed time has elapsed (“NO” in S44) without detecting an action other than connection of the ignition switch IG-SW (“NO” in S46; procedure B), the action monitoring unit 20b normally ends the ignition switch IG-SW connection monitoring procedure S70, and normally ends the action monitoring procedure S12 (S90). If on the other hand the prescribed time has elapsed (“YES” in S44), or if an action other than connection of the ignition switch IG-SW is executed (“YES” in S46) before the prescribed time has elapsed (“NO” in S44), a log of the action state is stored in internal RAM of the remote startup device 20 (S48), and the action monitoring procedure S12 ends abnormally.

By means of these procedures of the action monitoring unit 20b, as cases in which there is a high probability of intrusion by a third party, first, a case in which a door is unlocked without using a key 2, or the ignition switch IG-SW is connected, or similar can be detected. And, in these cases, the engine startup unit 20a changes the ignition signal IG to off to stop the engine as described above, so that vehicle theft can be prevented.

In addition, it is possible to detect cases in which more time than is necessary for user actions has been taken, and in such cases to change the ignition signal IG to off and stop the engine, so that safety with respect to vehicle theft can be further improved. And, cases in which actions other than user actions are performed can be detected, and in such cases the ignition signal IG can be changed to off to stop the engine, so that safety with respect to vehicle theft can be further improved. However, the first embodiment also comprises cases in which, of these two cases, one or both of the operation procedures are omitted.

On the other hand, so long as user actions are performed normally, the ignition signal IG is maintained in the on state for a fixed time. And when user actions end normally, that is, when the ignition switch IG-SW is connected and the ignition signal IG output by the ignition switch IG-SW changes to on, the ignition signal IG output by the remote startup device 20 is changed to off. Hence the user need not again connect the starter switch ST-SW and start up the engine, so that convenience to the user is improved.

Next, a first modified example of the first embodiment is explained.

### (1) FIRST MODIFIED EXAMPLE

In the first embodiment, as shown in FIG. 4 and FIG. 5, when user actions do not end within a prescribed action time, it is judged that there is a high probability of intrusion by a third party, and the action ends abnormally; however, even in cases in which a legitimate user performs actions, the user actions may end abnormally. For example, when in the midst of user actions a user notices that he has forgotten or lost something, if no actions are performed on the vehicle, then the action time elapses and an abnormal end results. When in this case the engine stops, the user must again perform an action to start up the engine. However, if after unlocking a door and opening a door the engine running state is maintained, safety with respect to theft is reduced.

Hence in a first modified example, when prescribed conditions are all satisfied, the engine startup unit 20a maintains the on value of the ignition signal IG. Specifically, when user actions performed in the order of door unlocking, door opening, entry, door closing, and connection of the ignition switch IG-SW are halted midway, the key 2 is extracted, a door is opened, a passenger exits, a door is closed, and the door is locked, in this order, then the state in which the vehicle is locked is restored, and there is a reduced danger of theft, so that the ignition signal IG is maintained at the on value. By this means, when a user again enters the vehicle, the engine running state is preserved, so that convenience to the user can be improved.

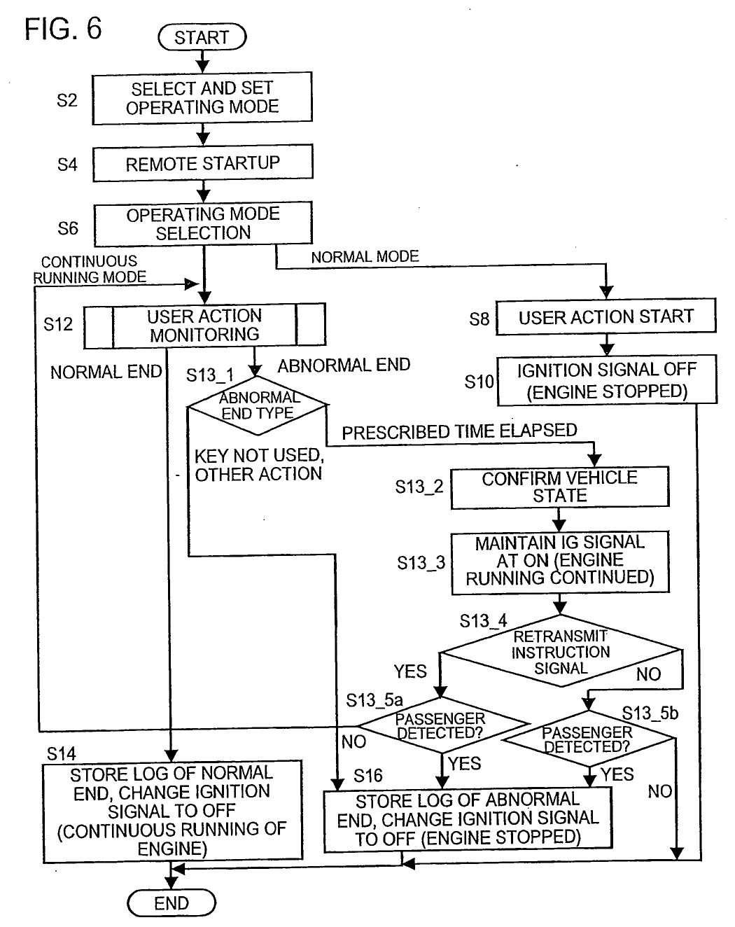

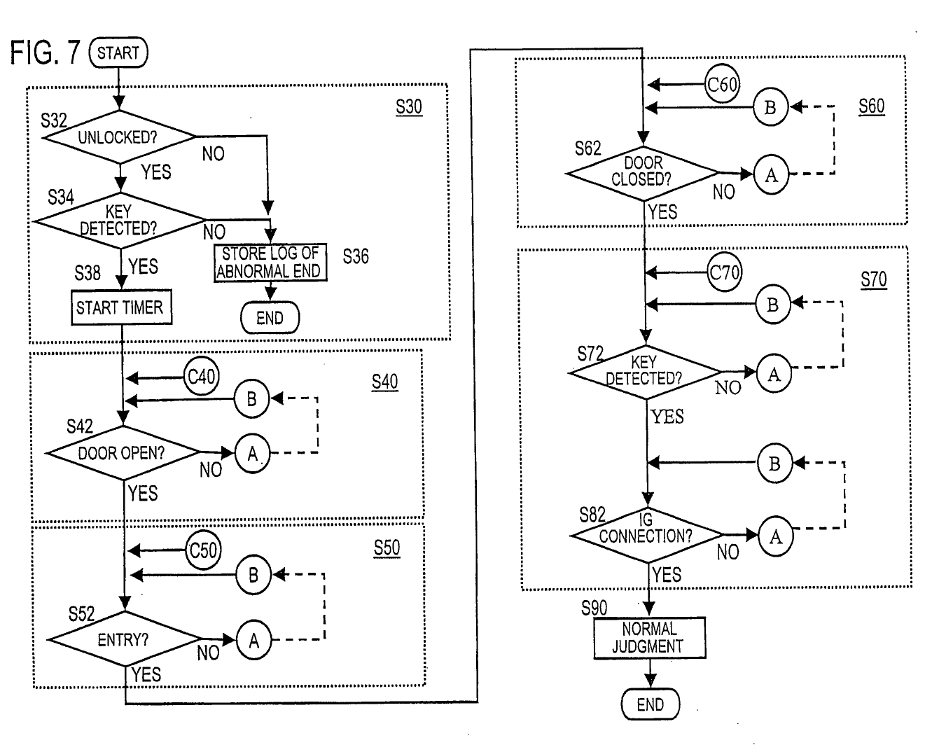

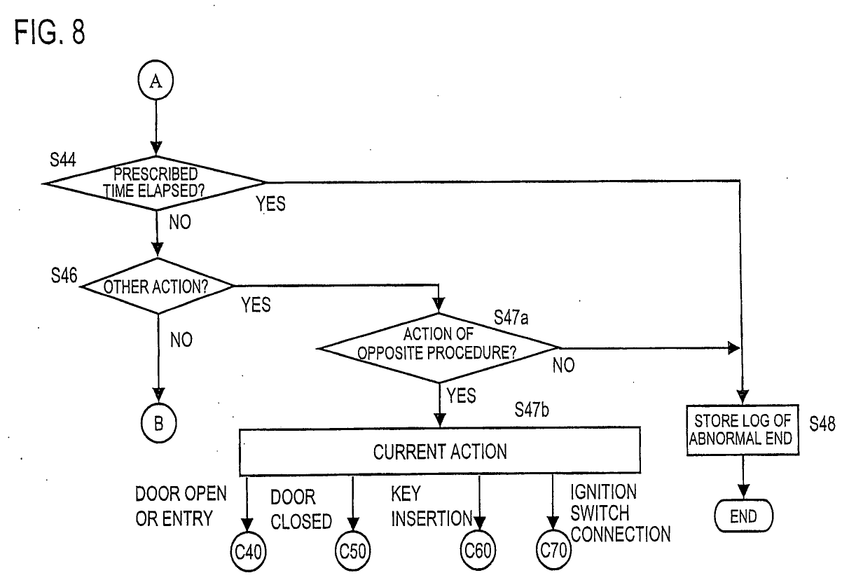

FIG. 6 is a flowchart explaining the operation procedure of the remote startup device 20 in the first modified example. The flowchart of FIG. 6 is the flowchart of FIG. 3 with the procedures S13_1, S13_2, S13_3, S13_4, S13_5a, and S13_5b added. FIG. 7 is a flowchart explaining a procedure example in the first modified example for the operation procedure of the action monitoring unit 20b shown in FIG. 4. The procedure of FIG. 7 is the procedure of FIG. 4 with the procedures C40, C50, C60, and C70 added. And, FIG. 8 is a flowchart explaining a procedure example in the first modified example for the operation procedure of the action monitoring unit 20b shown in FIG. 5. The flowchart of FIG. 8 is the flowchart of FIG. 5 with the procedures S47a and S47b added, and shows the subroutine procedures for the door opening monitoring procedure S40, passenger entry monitoring procedure S50, door closing monitoring procedure S60, and ignition switch IG-SW connection monitoring procedure S70 of the action monitoring unit 20b shown in FIG. 7.

First, for convenience of explanation, FIG. 7 and FIG. 8 are explained. In the midst of the door opening monitoring procedure S40, passenger entry monitoring procedure S50, door closing monitoring procedure S60, and ignition switch IG-SW connection monitoring procedure S70 of the action monitoring unit 20b shown in FIG. 7, the action monitoring unit 20b transitions to the subroutine of FIG. 8, detects another action (“YES” in S46), and proceeds to the procedure S47a.

In the procedure S47a, the action monitoring unit 20b checks to determine whether the action detected is an action corresponding to the opposite procedure of the current user action (S47a). Here, if the current user action is door opening the opposite procedure is door locking; if the current user action is vehicle entry the opposite procedure is door closing; if the current user action is door closing the opposite procedure is vehicle exiting; if the current user action is insertion of a key into the key cylinder 4 the opposite procedure is door opening; and if the current user action is ignition switch IG-SW connection the opposite procedure is key extraction. When the result is “YES” processing proceeds to procedure S47b, and if the current user action is door opening or vehicle entry, processing returns to before confirmation of door opening (C40); if the current user action is door closing, processing returns to before confirmation of vehicle entry (C50); if the current user action is key insertion, processing returns to before confirmation of door closing (C60); and if the current user action is ignition switch IG-SW connection, processing returns to before confirmation of key insertion (C70). On the other hand, when the result in procedure S47a is “NO”, a log of the action state is stored in RAM, and the action monitoring procedure S12 ends abnormally (S48). This procedure is repeated to return to the state in which the vehicle doors are locked (C40), and if door opening is not again performed (“NO” in S42), when a prescribed action time has elapsed the user action monitoring procedure ends abnormally (“YES” in S44, S48).

Next, FIG. 6 is explained. In a case in which the user action monitoring procedure S12 comprising the above subroutine ends abnormally, when an abnormal end occurs due to elapsing of the prescribed time (“Prescribed time elapsed” in S13_1), the engine startup unit 20a judges whether conditions to preserve the engine running state obtain. Specifically, a check as to whether the state in which the vehicle doors are locked has been restored is performed (S13_2). When the state of locked doors is restored, the engine startup unit 20a maintains the ignition signal IG at the on value, and preserves the engine running state (S13_3).

When this procedure is performed, the engine running state is preserved until the user again normally ends user actions, or until the prescribed action time elapses from the initial unlocking of a door. And, when the prescribed action time has elapsed, if the vehicle doors are in the lock stated, the engine running state is extended. Hence even when the initial action time from the time the user again begins user actions has elapsed, action time again begins to be measured from the time of the resumption of user actions. As a result, the user has an adequate amount of time to enter the vehicle.

In this case, when initially, during continuation of the timer which was started at the time the door was unlocked, the user again enters the vehicle, time may run out in the midst of actions. Hence when user halts the initial user action and again locks the vehicle door, if the user again transmits a startup instruction signal from the remote control terminal 10, and the remote startup device 20 receives this signal, then a procedure of returning to before the procedure S12 (“YES” in S13_4) can be added. In this case, it can be judged that the user is explicitly requesting continuation of the engine running state. Hence by maintaining the on value for the ignition signal IG, the engine running state is maintained, and moreover the timer is reset at the time the door is again unlocked to begin time measurement. By this means, the user has an adequate amount of time to end user actions. As a result, convenience to the user is improved.

When the procedures S13_1 to S13_4 are performed, and the ignition signal IG is maintained at the on value, it may be supposed that the user is outside the vehicle. Hence when the ignition signal IG is maintained at the on value, and a passenger is detected inside the vehicle, there is the possibility of an intruder, and so a procedure may be added in which the engine startup unit 20a changes the ignition signal IG to off and stops the engine (“YES” in S13_5a and S13_5b). By this means, safety with respect to vehicle theft can be improved.

### (2) SECOND MODIFIED EXAMPLE

In this aspect, the remote startup device 20 may judge from user actions performed on the vehicle that there is a high probability of intrusion by a third party, and may stop the engine. Separately from this, in recent years there are cases in which an immobilizer is used as a method of preventing vehicle theft.

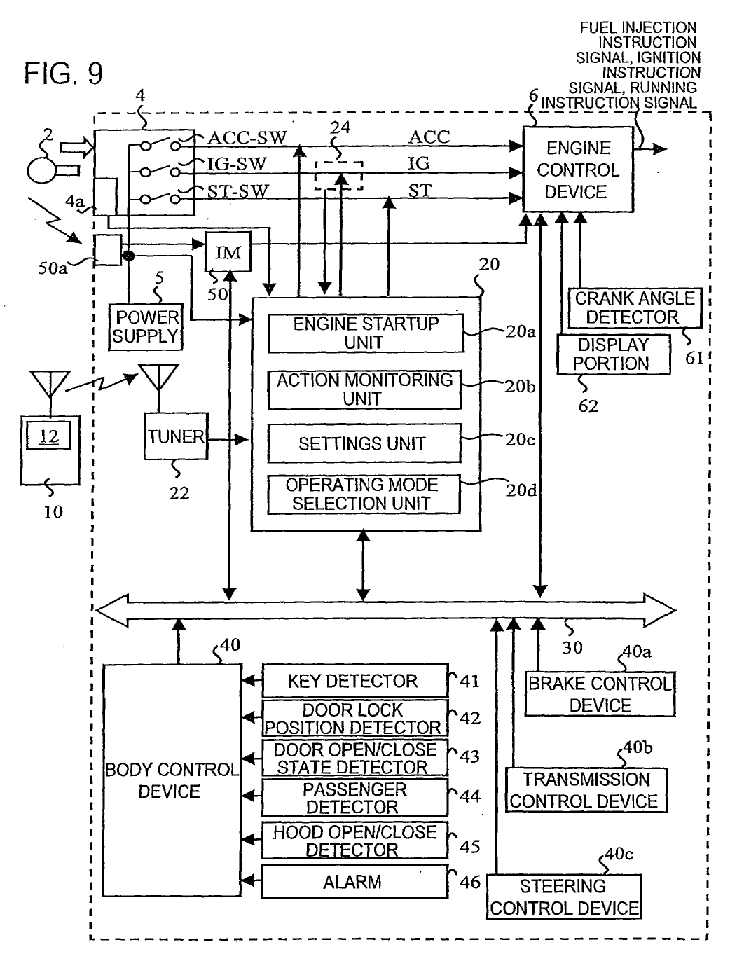

FIG. 9 shows a configuration example for a case in which the engine startup device 20 is used together with an immobilizer. The immobilizer 50 is an electronic control device which, when a user inserts a key 2 into the key cylinder 4, receives an identification signal transmitted from a wireless transmitted comprised by the key 2 by means of a wireless receiver 50a comprised in proximity to the key cylinder 4, and by performing authentication of the identification information, judges whether or not the key is legitimate. And, when authentication is successful, the immobilizer 50 permits engine startup, whereas when authentication fails an instruction signal prohibiting engine startup is output to the engine control device 6. By this means, engine startup is stopped when an illicit key is used, and vehicle theft is prevented.

When an immobilizer 50 and remote startup device 20 are used together, even when engine startup is executed by the remote startup device 20, there are cases in which the engine is stopped by the immobilizer 50. For example, when a third party has used a duplicated key to intrude into a vehicle the engine of which has been started remotely, user actions are performed normally, so that engine startup is performed by the remote startup device 20. However, in this case when the duplicated key is inserted into the key cylinder 4, authentication fails, and so the immobilizer 50 stops the engine.

In such a case, the engine startup unit 20a of the remote startup device 20 judges whether the engine is in the running state or in the stopped state, to detect that the engine has been stopped by the immobilizer 50. At this time, the engine startup unit 20a can acquire the engine rotation rate from the engine control device 6, and if the engine rotation rate is at or below a constant value, can judge that the engine is in the stopped state. Or, the engine startup unit 20a can acquire log information indicating authentication failure from the immobilizer 50 via the onboard LAN 30, to detect that the engine has been stopped by the immobilizer 50. Or, in cases in which the first embodiment is applied to a so-called hybrid vehicle, in which the engine control device switches between driving of the wheels by the engine and driving of the wheels by an electric motor according to the speed and load, the engine startup unit 20a can acquire a signal indicating the engine is in the stopped state from the engine control device 6, to detect that the engine is stopped.

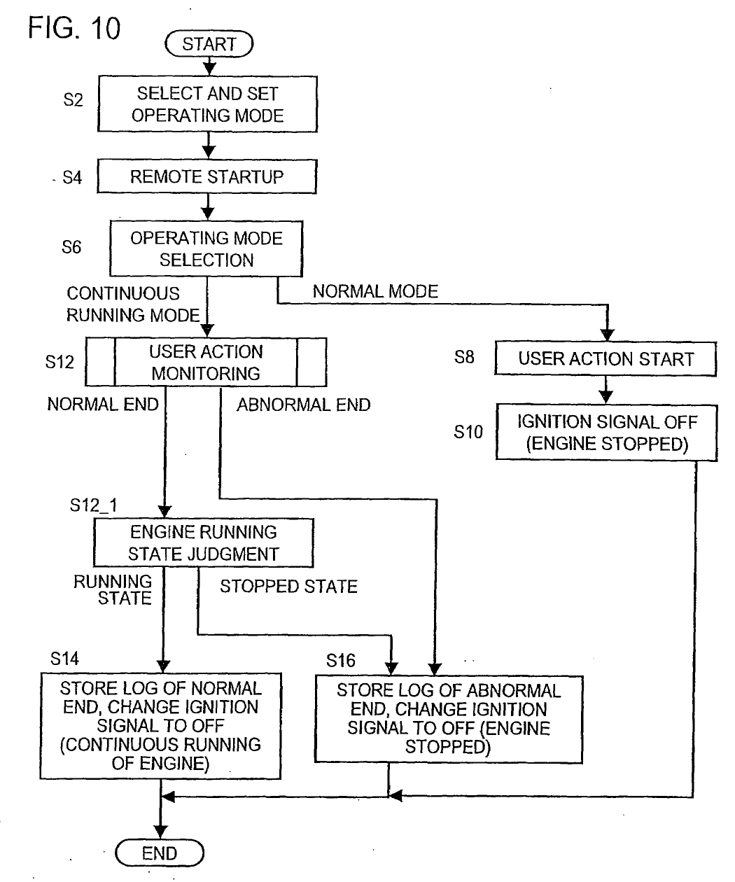

FIG. 10 is a flowchart explaining the operation procedure of the remote startup device 20 in the second modified example. This procedure is the procedure of FIG. 3, with the procedure S12_1 added. When in procedure 12 user actions end normally, the engine startup unit 20a decides the engine running state (S12_1). And, when the engine is in the running state (“Running state” in S12_1), the engine startup unit 20a stores in ROM a log indicating normal engine startup, and changes the ignition signal IG to off (S14). When on the other hand the engine is in the stopped state and not in the running state (“Stopped state” in S12_1), a log indicating an abnormal end is stored in ROM, and the ignition signal IG is changed to off (S16).

By means of this procedure, control can be executed which is coordinated with engine control by an immobilizer or other control device, and more reliable theft prevention is possible.

The above-described first modified example and second modified example can be combined and implemented.

In the first embodiment, the engine startup unit 20a of the remote startup device 20 judges that there is a high probability of intrusion by a third party, and changes the ignition signal IG to off, when an action which is performed using a key 2, such as unlocking of a door or connection of the ignition switch IG-SW, is performed without using a key. This first embodiment can be applied to a system in which, in response to an unlock instruction signal wirelessly transmitted from an electronic key having wireless transmission means, a door is unlocked. In such a system, when door unlocking is performed without reception of such an unlock instruction signal, the engine startup unit 20a changes the ignition signal IG to off, to stop the engine when there is a high probability of intrusion by a third party.

Further, the first embodiment can be applied to a system in which identification information transmitted wirelessly from an electronic key is authenticated, and when, in place of a key action, a user operates a pushbutton or other action switch provided in proximity to the steering wheel, the ignition switch IG-SW is connected in response. In such a system, the engine startup unit 20a changes the ignition signal IG to off when door unlocking is performed without reception of an unlock instruction signal, so that the engine is stopped when there is a high probability of intrusion by a third party. In such a case, the electronic key may also serve as the remote control terminal 10, or may be separate.

In such a case, a portable key of this invention corresponds to an electronic key which transmits an action instruction signal to operate a prescribed portion of the vehicle, causing the remote startup device to execute operation of the portion. And, the key detector 4a in FIG. 1 is replaced with a receiver which receives operation instruction signals to operate and open or close the accessory switch ACC-SW, ignition switch IG-SW, and starter switch ST-SW. Hence the action monitoring unit 20b judges whether or not a portable key is used according to whether the receiver receives such operation instruction signals. Moreover, the key detector 41 is replaced by a receiver of operation instruction signals to operate and open or close door locks. And, the action monitoring unit 20b judges whether a portable key is used according to whether this receiver receives operation instruction signals.

As explained above, by means of the first embodiment, convenience to the user can be improved without detracting from safety with respect to vehicle theft during remote startup of the engine.

### 2. Second Aspect

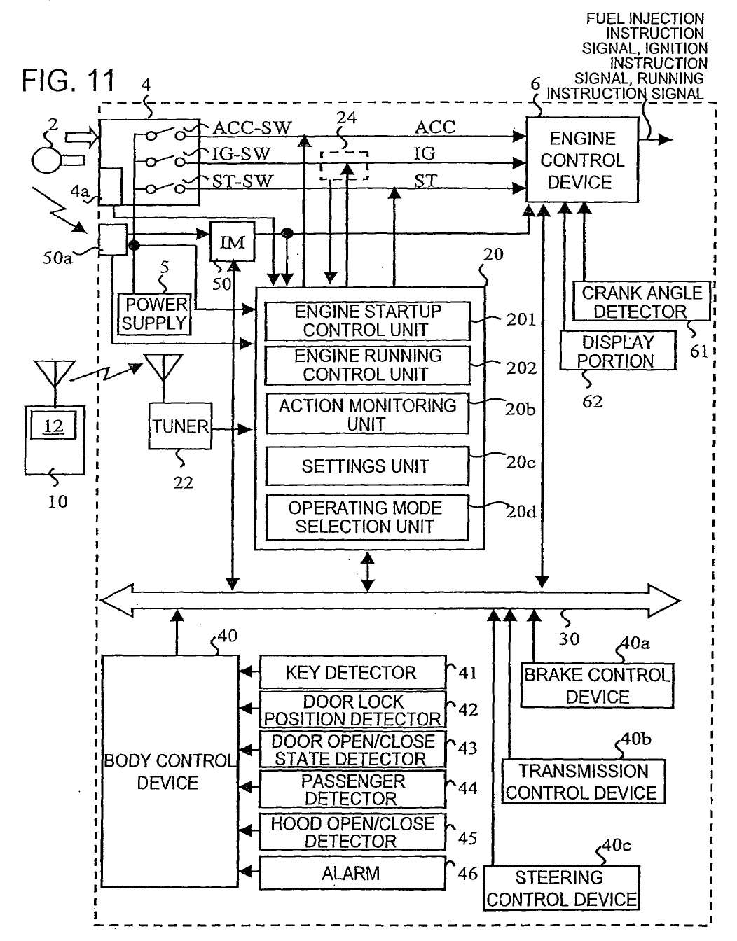

FIG. 11 is a block diagram explaining the configuration of the remote startup device in a second embodiment. FIG. 11 corresponds to the configuration in FIG. 9 of the first embodiment. In the second embodiment, an immobilizer 50 receives, by means of a wireless receiver 50a, an identification signal transmitted from a wireless transmitter carried by the user even when the user does not use a key 2, and by authenticating the identification information, judges whether the key is legitimate. If authentication is successful, the immobilizer 50 permits startup of the engine, and if authentication fails, an instruction signal prohibiting engine startup is output to the remote startup device 20 and to the engine control device 6.

In the remote startup device 20, identification information is acquired via the immobilizer 50 or from the wireless receiver 50a, and the action monitoring unit 20b performs authentication. Hence in addition to detection of use of a portable key 2, transmission of an identification signal from a wireless transmitter carried by the user in place of the portable key 2, reception by the wireless receiver 50a, and authentication of an identification number, is also comprised by key identification.

In the second embodiment, the remote startup device 20 has, in place of an engine startup unit 20a, an engine startup control unit 201 and an engine running control unit 202. The engine startup control unit 201 and engine running control unit 202 comprise programs describing operation procedures, explained below, and a CPU which operates according to the programs. Operation of the engine startup control unit 201 and engine running control unit 202 corresponds to operation of the engine startup unit 20a in FIG. 9.

The engine startup control unit 201 inputs pseudo-on signals to the signal lines of the accessory signal ACC, ignition signal IG, and starter signal ST in response to a startup instruction signal. Here, the ignition signal IG corresponds to a “control signal” which starts the engine and induces the running state. In this way, the engine is started up even when the accessory switch ACC-SW, ignition switch IG-SW, and starter switch ST-SW are in the open state.

The engine running control unit 202 receives input of the engine rotation rate from the engine control device 6 via the onboard LAN (Local Area Network) 30. And, when the engine rotation rate has reached a prescribed rotation rate, the engine running control unit 202 changes the starter signal ST to off, and maintains the ignition signal IG at on. By this means, the engine running state is preserved until the user enters the vehicle. The engine running control unit 202 detects that the engine has been stopped by the immobilizer 50 by acquiring from the immobilizer 50, via the onboard LAN 30, log information of authentication failure, and changes the ignition signal IG to off.

Further, the engine running control unit 202 also changes the ignition signal IG to off to stop the engine when there is a high probability of intrusion by a third party. On the other hand, when there is a high probability that a legitimate user is entering, engine running is continued. That is, operation is in the continuous running mode. By this means, vehicle theft is prevented. In addition, in the case of a legitimate user there is no need to again start up the engine, so that convenience can be improved.

The operation procedure of the remote startup device 20 in the second embodiment is explained. In the second embodiment, the remote startup device 20 executes the procedure explained in FIG. 3. Here the explanation of FIG. 3 applies, except for the following point. That is, the operations performed by the engine startup unit 20a in the explanation of FIG. 3 are here performed by either the engine startup control unit 201 or by the engine running control unit 202. Specifically, the procedure S4 to perform remote startup is performed by the engine startup control unit 201. And, the procedures S10, S14, S16 to change the ignition signal IG to off are performed by the engine running control unit 202.

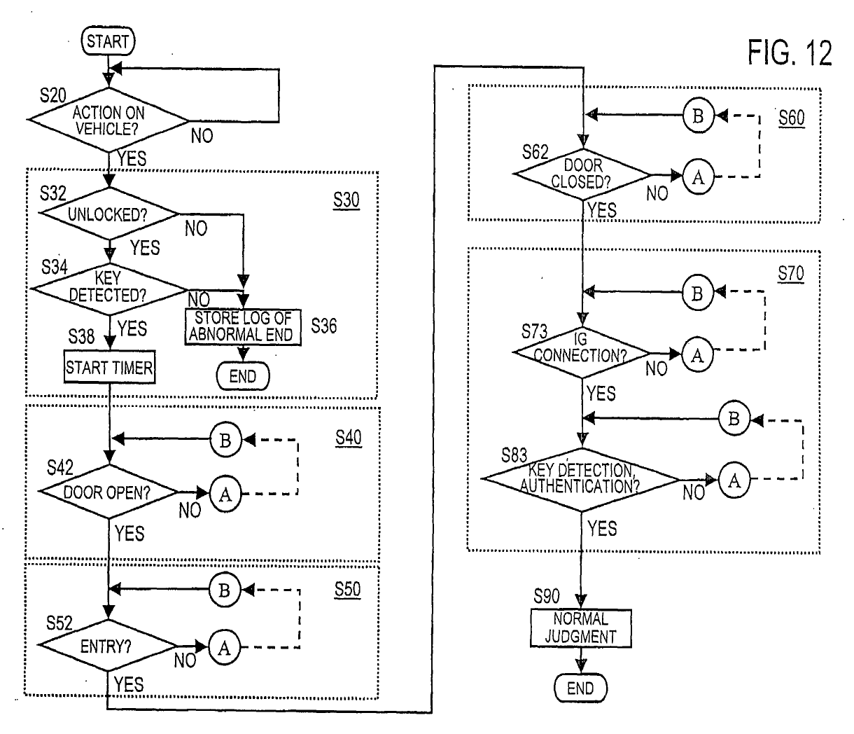

FIG. 12 is a flowchart explaining the operation procedure of the action monitoring unit 20b in the second embodiment. FIG. 12 corresponds to the subroutine of procedure S12 in FIG. 3. The procedure of FIG. 12 corresponds to a modified example of the procedure of FIG. 4 in the first embodiment. And, the procedure of FIG. 5 is applied to the subroutine continued from procedure A in FIG. 12.

Here, differences with the procedure of FIG. 4 are explained, and redundant explanations are omitted. First, prior to the door unlocking monitoring procedure S30, the action monitoring unit 20b monitors actions on the vehicle (S20). Here, actions on the vehicle include door unlocking. Hence when door unlocking is detected (“YES” in S20), processing proceeds to the door unlocking monitoring procedure S30.

The door unlocking monitoring procedure S30, door opening monitoring procedure S40, passenger entry monitoring procedure S50, and door closing monitoring procedure S60 are the same as in FIG. 4, and so explanations are omitted.

In the first half of the ignition switch IG-SW connection monitoring procedure S70, when the action monitoring unit 20b detects ignition switch IG-SW connection by means of the ignition signal detection portion 24 (“YES” in S73), processing proceeds to S83. On the other hand, when ignition switch IG-SW connection is not detected (“NO” in S73), the subroutine of FIG. 5 is performed (procedure A). That is, when, before the prescribed time has elapsed (“NO” in S44), the ignition switch IG-SW connection is detected (“YES” in S73) without detecting an action other than ignition switch IG-SW connection (“NO” in S46, procedure B), the action monitoring unit 20b proceeds to S83. On the other hand, when the prescribed time has elapsed (“YES” in S44), and when an action other than ignition switch IG-SW connection is performed (“YES” in S46) before the prescribed time has elapsed (“NO” in S44), a log of the action state is stored in internal RAM of the remote startup device 20 (S48), and the action monitoring procedure S12 ends abnormally.

Next, in the second half of the ignition switch IG-SW connection monitoring procedure S70, when insertion of a key 2 is detected at the time of connection of the ignition switch IG-SW, and moreover an identification signal transmitted from the wireless transmitter comprised by the key 2 is authenticated by the immobilizer 50 (“YES” in S83), the action monitoring unit 20b proceeds to S90, and the action monitoring procedure S12 ends normally (S90). If insertion of a key 2 is not detected at the time of connection of the ignition switch IG-SW, or if the identification signal is not authenticated (“NO” in S83), the subroutine of FIG. 5 is performed (procedure A). That is, when, before the prescribed time has elapsed (“NO” in S44), insertion of a key 2 is detected, and moreover the identification signal is authenticated (“YES” in S83), without detecting an action other than insertion of the key 2 (“NO” in S46, procedure B), the action monitoring unit 20b proceeds to S90. On the other hand, when the prescribed time has elapsed (“YES” in S44), and when an action other than insertion of a key 2 is performed (“YES” in S46) before the prescribed time has elapsed (“NO” in S44), an action state log is stored in internal RAM of the remote startup device 20 (S48), and the action monitoring procedure S12 ends abnormally.

By means of these procedures of the action monitoring unit 20b, as cases in which there is a high probability of intrusion by a third party, cases in which a door is unlocked or the ignition switch IG-SW is connected without using a key 2 can be detected, as explained in FIG. 4. And, in such cases the engine running control unit 202 described above changes the ignition signal IG to off to stop the engine, so that vehicle theft can be prevented. Here, use of a key 2 is confirmed at two times, which are when a door is unlocked and when the ignition switch is connected, and if confirmation is not possible, the engine is stopped. And, when use of a key 2 cannot be confirmed at the time of door unlocking, the engine is stopped immediately. In this way, safety is secured.

At the time of door unlocking and when the ignition switch IG-SW is connected the insertion of a key 2 may be detected, or instead, detection is possible, that is, the legitimacy of the user can be confirmed, by authenticating identification information. Further, at the time of ignition switch connection, identification information can be combined with confirmation of a legitimate key to improve safety.

In addition to this, cases are detected in which more than the time necessary for user actions is taken, and in such cases the ignition signal IG is changed to off and the engine stopped, so that safety with respect to vehicle theft can be further improved. And, cases in which an action other than a user action is performed can be detected, and at such times the ignition signal IG is changed to off and the engine stopped, so that safety with respect to vehicle theft can be further improved.

On the other hand, so long as user actions are performed normally, the ignition signal IG is maintained in the on state for a fixed length of time, and engine running is continued. And, when user actions end normally, that is, when the ignition switch IG-SW is connected and the ignition signal IG output by the ignition switch IG-SW changes to on, the ignition signal IG output by the remote startup device 20 is changed to off. Hence the user need not perform an action to again connect the starter switch ST-SW and need not wait until the engine is started, so that user convenience is improved.

### (1) FIRST MODIFIED EXAMPLE

In a first modified example, when an action on the vehicle is performed prior to detecting use of a key 2 at the time the door is unlocked, the engine is stopped immediately. By this means, safety can be improved.

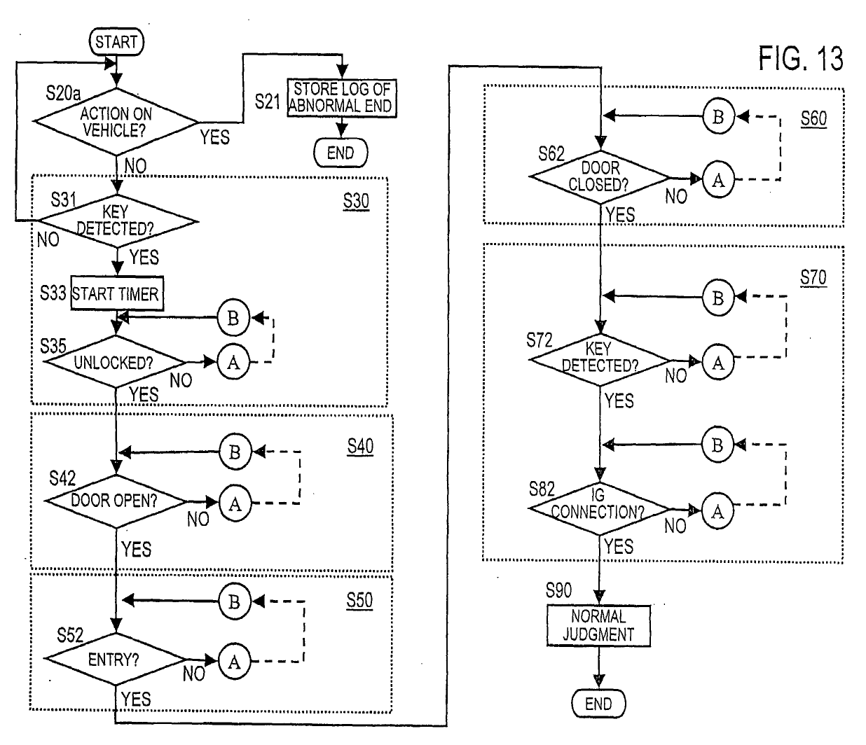

FIG. 13 is a flowchart explaining the operation procedure of the action monitoring unit 20b in the first modified example. FIG. 13 corresponds to the subroutine of the procedure S12 in FIG. 3, and corresponds to the modified example of the procedure of FIG. 4 in the first embodiment. Here, differences with the procedure of FIG. 4 are explained, and redundant explanations are omitted. Also, the subroutine continuing from the procedure A of FIG. 13 is applied to the procedure shown in FIG. 5.

First, the action monitoring unit 20b monitors actions on the vehicle until the completion of key detection in the door unlocking monitoring procedure S30 (S20a). Here, actions on the vehicle include door unlocking, as well as door opening and closing, shift and brake actions, steering actions, as well as hood opening and closing, the alarm sounding, and battery removal. If any of these actions is detected (“YES” in S20a), that is, if an action is performed on the vehicle before detection of a key 2 in procedure S31 described below, a log indicating a key 2 was not detected is stored in internal RAM of the remote startup device 20 (S21), and the action monitoring procedure S12 ends abnormally.

On the other hand, when an action such as the above is not performed (“NO” in S20a), upon detection of a key 2 in the door unlocking monitoring procedure S30 (“YES” in S31), a timer which measures a prescribed action time is started (S33). And, when the door is unlocked (“YES” in S35), processing proceeds to the door opening monitoring procedure S40.

When in procedure S35 door unlocking is not detected (“NO” in S35), the subroutine of FIG. 5 is performed (procedure A). That is, when the prescribed time has elapsed (“YES” in S44), or when an action other than door unlocking has been performed (“YES” in S46) before the prescribed time has elapsed (“NO” in S44), the action monitoring unit 20b stores a log of the action state in internal RAM of the remote startup device 20 (S48), and the action monitoring procedure S12 ends abnormally.

In this way, in the door unlocking monitoring procedure S30, when before the prescribed time has elapsed (“NO” in S44) door unlocking is detected (“YES” in S35) without the detection of an action other than door unlocking (“NO” in S46, procedure B), the action monitoring unit 20b normally ends the door unlocking monitoring procedure S30, and proceeds to the door opening monitoring procedure S40.

The door opening monitoring procedure S40, passenger entry monitoring procedure S50, door closing monitoring procedure S60, and ignition switch IG-SW connection monitoring procedure S70 are the same as in FIG. 4, and so explanations are omitted.

In the first modified example, when an action is performed on the vehicle before detection of use of a key 2, the engine is immediately stopped. By this means, safety can be improved.

### (2) SECOND MODIFIED EXAMPLE

In the procedures shown in FIG. 12 and FIG. 5, or in FIG. 13 and FIG. 5, when in the midst of the door opening monitoring procedure S40, passenger entry monitoring procedure S50, door closing monitoring procedure S60, and ignition switch IG-SW connection monitoring procedure S70, an action other than the actions of interest is performed, the engine is stopped. However, there may be cases in which door opening and closing, shift or braking actions, steering actions, or other actions may be performed by a legitimate user in the midst of the above actions. If in such cases the engine is stopped uniformly, there remains room for improvement of convenience.

In the second modified example, after once detecting use of a key 2, the conditions for stopping the engine are relaxed. By this means convenience can be further improved, while securing safety.

In the second modified example, when the procedure of FIG. 12 is performed, the subroutine following procedure A is modified.

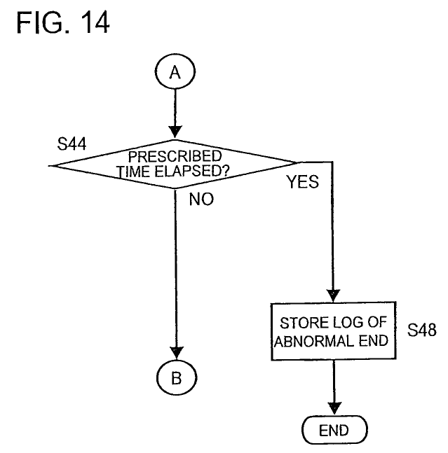

FIG. 14 is a flowchart of the subroutine in the second modified example. The characteristic procedure in the second modified example is explained using FIG. 12 and FIG. 14.

Once use of a key 2 is detected in the procedure S34 of FIG. 12, or after authentication of an identification signal, in the door opening monitoring procedure S40, passenger entry monitoring procedure S50, door closing monitoring procedure S60, or ignition switch IG-SW connection monitoring procedure S70, when an action other than each of these actions is performed, the engine is not stopped.

That is, after the prescribed time has elapsed in FIG. 14 (“YES” in S44), a log of the action state is stored in internal RAM of the remote startup device 20 (S48), and the action monitoring procedure S12 ends abnormally. However, so long as the prescribed time has not elapsed (“NO” in S44), monitoring for performance of the original action is performed (procedure B).

In this way, in the second modified example, when an action other than door unlocking is performed before detection of use of a key 2, the engine is immediately stopped, and in addition, once use of a key 2 is detected, or after authentication of an identification signal, the conditions for stopping the engine are relaxed. By this means, convenience can be improved while securing safety.

### (3) THIRD MODIFIED EXAMPLE

In a third modified example, when all prescribed conditions are satisfied, the engine running control unit 202 maintains the ignition signal IG at the on value. Specifically, when user actions performed in the order of door unlocking, door opening, entry, door closing, and ignition switch IG-SW connection are halted midway, the key 2 is removed, and a procedure is performed in which the door is opened, the passenger exits, the door is closed, and the door is locked, then the state of the vehicle being locked has been restored and there is reduced danger of theft, so that the ignition signal IG is maintained at the on value. By this means, when the user again enters the vehicle the engine running state is preserved, so that convenience to the user can be improved.

In the third modified example, the procedure shown in FIG. 6 of the first embodiment is performed. However, in the explanation of FIG. 6 the operations performed by the engine startup unit 20a are here performed by the engine startup control unit 201 or by the engine running control unit 202. Specifically, the procedure S4 to perform remote startup is performed by the engine startup control unit 201. And, the procedures S10, S14, S16 to change the ignition signal IG to off are performed by the engine running control unit 202. Also, the procedure S13_2 to determine whether the state in which the vehicle doors are locked has been restored, and the procedure S13_3 to maintain the ignition signal IG at the on value and preserve the engine running state when the doors-locked state has been restored, are performed by the engine running control unit 202.

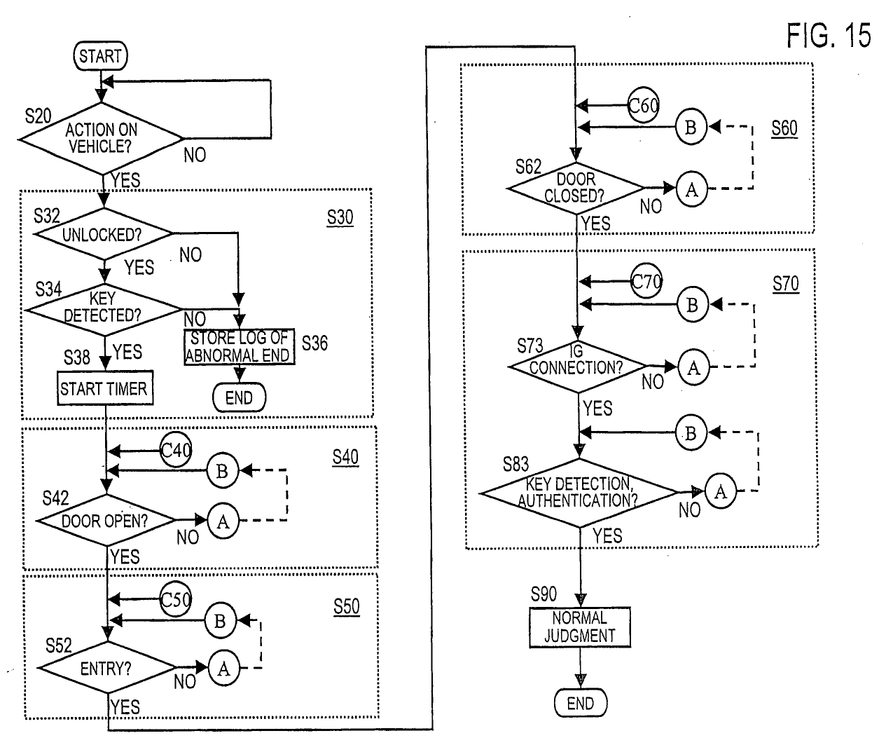

FIG. 15 is a flowchart explaining the operation procedure of the action monitoring unit 20b in the third modified example. FIG. 15 corresponds to the subroutine of the procedure S12 in FIG. 6. The procedure of FIG. 15 corresponds to the modified example of the procedure of FIG. 7 in the first embodiment. And, the procedure shown in FIG. 8 is applied to the subroutine following procedure A in FIG. 15.

Here, differences with the procedure of FIG. 7 are explained, and redundant explanations are omitted. First, prior to the door unlocking monitoring procedure S30, actions on the vehicle are monitored by the action monitoring unit 20b (S20). Here, actions on the vehicle include door unlocking. When door unlocking is detected (“YES” in S20), processing proceeds to the door unlocking monitoring procedure S30.

The door unlocking monitoring procedure S30, door opening monitoring procedure S40, passenger entry monitoring procedure S50, and door closing monitoring procedure S60 are the same as in FIG. 7, and so explanations are omitted.

In the first half of the ignition switch IG-SW connection monitoring procedure S70, upon detection of connection of the ignition switch IG-SW by the ignition signal detection portion 24 (“YES” in S73), the action monitoring unit 20b proceeds to S83. When on the other hand ignition switch IG-SW connection is not detected (“NO” in S73), the subroutine of FIG. 8 is performed (procedure A).

That is, when ignition switch IG-SW connection is detected (“YES” in S73) before the prescribed time has elapsed (“NO” in S44), without detection of an action other than ignition switch IG-SW connection (“NO” in S46, procedure B), the action monitoring unit 20b proceeds to S83. On the other hand, when the prescribed time has elapsed (“YES” in S44), an action state log is stored in internal RAM of the remote startup device 20 (S48), land the action monitoring procedure S12 ends abnormally.

When, before the prescribed time has elapsed (“NO” in S44), an action other than ignition switch IG-SW connection is performed (“YES” in S46), processing proceeds to S47a. In the procedure S47a, the action monitoring unit 20b checks whether the detected action is the action corresponding to the opposite procedure of the current user action (S47a). Here, the current user action is ignition switch IG-SW connection, so that key removal corresponds to the opposite action. And, in the case of “YES” processing proceeds to S47b, and because the current user action is ignition switch IG-SW connection, the state prior to confirmation of IG-SW connection is restored (C70).

Next, in the second half of the ignition switch IG-SW connection monitoring procedure S70, when insertion of a key 2 is detected upon ignition switch IG-SW connection, and/or an identification signal transmitted from a wireless transmitter carried by a user is authenticated (“YES” in S83), the action monitoring unit 20b proceeds to S90, and the action monitoring procedure S12 ends normally (S90). When ignition switch IG-SW connection is performed and insertion of a key 2 is not detected, and an identification signal is not authenticated (“NO” in S83), the subroutine of FIG. 8 is performed (procedure A). That is, when, before the prescribed time has elapsed (“NO” in S44), insertion of a key 2 is detected and moreover an identification signal is authenticated (“YES” in S83) without detecting an action other than insertion of a key 2 (“NO” in S46, procedure B), the action monitoring unit 20b proceeds to S90. On the other hand, when the prescribed time has elapsed (“YES” in S44), an action state log is stored in internal RAM of the remote startup device 20 (S48), and the action monitoring procedure S12 ends abnormally. Also, when before the prescribed time has elapsed (“NO” in S44) an action other than ignition switch IG-SW connection is performed (“YES” in S46), processing proceeds to S47a. Because the current user action is ignition switch IG-SW connection, the action monitoring unit 20b checks whether the opposite action of key removal has been performed. If the result is “YES” processing proceeds to S47b, and because the current user action is ignition switch IG-SW connection, the state prior to IG-SW connection confirmation is restored (C70).

Thus in the third modified example, when an action is performed on the vehicle prior to detection of use of a key 2 when a door is unlocked, the engine is immediately stopped. By this means, safety can be improved. In addition, when user actions performed in the order of door unlocking, door opening, entry, door closing, and ignition switch IG-SW connection are halted, the key 2 is removed, and door opening, exit, door closing, and door locking are performed, then the state in which the vehicle is locked has been restored, and there is little danger of theft, so that the on value of the ignition signal IG is maintained. By this means, when the user again enters the vehicle the engine running state is preserved, so that convenience to the user can be improved. That is, convenience can be improved while securing safety.

As explained above, by means of the second embodiment, convenience to the user can be improved without detracting from safety with respect to vehicle theft when the engine is started remotely.

1. A remote startup device, which starts an engine of a vehicle upon receiving wireless transmission of a startup instruction signal instructing startup of the engine, comprising:
an engine startup control unit, which starts the engine in response to the startup instruction signal;
an action monitoring unit, which monitors actions performed on the vehicle; and
an engine running control unit, which decides, after the engine has been started up, whether to continue or to stop running of the engine based on prescribed conditions,
wherein the engine running control unit detects a key at least two times, which are at the time of unlocking of a door of the vehicle and at the time of ignition connection, and continues running of the engine when the key is detected at both times, and stops running of the engine when the key is not detected at least one of the two times.

2. The remote startup device according to claim 1, wherein, after the key has been detected at a time of detection of the key, the engine running control unit modifies the prescribed conditions such that running of the engine is not as readily stopped as before the key is detected.

3. The remote startup device according to claim 2, wherein, when a prescribed action on the vehicle is detected before the key is detected at the time of the door unlocking, the engine running control unit stops running of the engine, and after the key is detected at the time of the door unlocking, the engine running control unit does not stop running of the engine even when the prescribed action is detected.

4. The remote startup device according to claim 2, wherein, when a prescribed action on the vehicle other than the door unlocking is detected before the key is detected at the time of the door unlocking, the engine running control unit stops running of the engine, and after the key is detected at the time of the door unlocking, the engine running control unit does not stop running of the engine even when the prescribed action on the vehicle other than the door unlocking is detected.

5. The remote startup device according to claim 2, wherein, when a prescribed action on the vehicle other than the door unlocking is detected before the key is detected at the time of the door unlocking, the engine running control unit stops running of the engine, and after the key is detected at the time of the door unlocking, the engine running control unit does not stop running of the engine when prescribed actions on the vehicle other than the door unlocking are detected in a prescribed order.

6. The remote startup device according to claim 1, wherein the engine startup control unit outputs, to an engine control device which controls the engine, a control signal to start up the engine in response to the startup instruction signal, and the engine running control unit stops output of the control signal upon detection of the key at the time of the ignition connection.

7. A remote startup device, comprising:
an engine startup unit, to which a startup instruction signal instructing startup of an engine of a vehicle is wirelessly transmitted, and which changes a control signal to on to put the engine into a running state in response to this startup instruction signal; and
an action monitoring unit, which monitors prescribed user actions performed on the vehicle after the control signal is changed to on,
wherein the engine startup unit executes a first operating mode in which, after the control signal is changed to on, the on value of the control signal is maintained until the user actions end, and when an action to operate a prescribed portion of the vehicle, among the user actions, is performed without using a portable key, the control signal is changed to off.

8. The remote startup device according to claim 7, wherein, when the user actions do not end within a prescribed time from the start of the user actions, the engine startup unit changes the control signal to off when the prescribed time has elapsed.

9. The remote startup device according to claim 7, wherein, when an action different from the user actions are performed on the vehicle, the engine startup unit changes the control signal to off.

10. The remote startup device according to claim 8, wherein, when the user actions are halted by a prescribed procedure, the engine startup unit maintains the on value of the control signal, even when the prescribed time has elapsed.

11. The remote startup device according to claim 10, wherein, when the startup instruction signal is transmitted while the on value of the control signal is maintained, the engine startup unit repeats the first operating mode.

12. The remote startup device according to claim 10, wherein, even when the on value of the control signal is maintained, when a passenger is detected in the vehicle, the engine startup unit changes the control signal to off.

13. The remote startup device according to claim 7, wherein even when the engine is in a stopped state when the user actions end, the engine startup unit changes the control signal to off.

14. The remote startup device according to claim 7, further comprising an operating mode selection unit, to which a selection signal instructing selection of an operating mode for the engine startup unit is wirelessly transmitted, and which performs selection in response to the selection signal, wherein the engine startup unit executes the first operating mode when the first operating mode is selected, and executes a second operating mode upon selection of the second operating mode in which, when the user actions are started after the control signal is changed to on, the control signal is changed to off.

15. The remote startup device according to claim 7, wherein the portable key is either a mechanical key which operates a prescribed portion of the vehicle, or is an electronic key which wirelessly transmits an operation instruction signal instructing operation of the prescribed portion to cause the remote startup device to execute the operation on the portion.

16. The remote startup device according to claim 9, wherein the portable key is either a mechanical key which operates a prescribed portion of the vehicle, or is an electronic key which wirelessly transmits an operation instruction signal instructing operation of the prescribed portion to cause the remote startup device to execute the operation on the portion.

17. The remote startup device according to claim 12, wherein the portable key is either a mechanical key which operates a prescribed portion of the vehicle, or is an electronic key which wirelessly transmits an operation instruction signal instructing operation of the prescribed portion to cause the remote startup device to execute the operation on the portion.

18. A remote startup system, comprising a remote control terminal, which wirelessly transmits a startup instruction signal instructing startup of an engine of a vehicle, and a remote startup device, which is mounted on the vehicle and receives the startup instruction signal,
wherein the remote startup device comprises an engine startup unit which changes a control signal to on to put the engine into a running state in response to the startup instruction signal, and an action monitoring unit which monitors prescribed user actions performed on the vehicle after the control signal is changed to on; and
the engine startup unit executes a first operating mode in which, after the control signal is changed to on, the on value of the control signal is maintained until the user actions end, and when an action to operate a prescribed portion of the vehicle, among the user actions, is performed without using a portable key, the control signal is changed to off.

19. The remote startup system according to claim 18, wherein, in response to action input selecting an operating mode of the engine startup unit, the remote control terminal wirelessly transmits a selection signal corresponding to the selection, the remote startup device further has an operating mode selection unit which selects the operating mode of the engine startup unit in response to the signal corresponding to the selection, and the engine startup unit executes the first operating mode when the first operating mode has been selected after the control signal is changed to on, and executes a second operating mode upon selection of the second operating mode in which the control signal is changed to off when the user actions are started.

20. A remote startup method for a vehicle engine, comprising:
a engine startup step of changing a control signal to on, which puts the engine into a running state, in response to a wirelessly transmitted startup instruction signal instructing startup of the engine; and
an action monitoring step of monitoring prescribed user actions performed on the vehicle after the control signal is changed to on,
wherein in the engine startup step, after the control signal is changed to on, the on value of the control signal is maintained until the user actions end, and when an action to operate a prescribed portion of the vehicle, among the user actions, is performed without using a portable key, the control signal is changed to off.
